(19) United States
(12) Patent Application Publication
(10) Pub. No.: US 2026/0108327 A1
(43) Pub. Date: Apr. 23, 2026

(54) 3D PRINTED OR OTHER ANATOMICAL AND CIRCULAR GINGIVAL HEALING CUFFS FOR USE WITH ABUTMENTS

(71) Applicant: ESTHETIC IMPLANT SOLUTIONS, LLC, Bountiful, UT (US)

(72) Inventors: Todd C. Liston, Pleasant View, UT (US); Mark H. Blaisdell, Bountiful, UT (US)

(21) Appl. No.: 19/364,736

(22) Filed: Oct. 21, 2025

Related U.S. Application Data
(60) Provisional application No. 63/710,443, filed on Oct. 22, 2024.

(51) Int. Cl. A61C 8/00; B33Y 80/00

(52) U.S. Cl. CPC A61C 8/008; A61C 8/0016; B33Y 80/00

(57) ABSTRACT

An assembly comprising an abutment and gingival healing cuff. The gingival healing cuff fits and mates over the abutment, wherein the cuff includes internal surfaces (e.g., at least one flat face, and at least one curved face) corresponding to the external surfaces of the abutment, so as to mate with one another. The gingival healing cuff can further include a rectangular box or other timing alignment structure positioned apical to a buccal alignment body, which serves as a buccal alignment marker once the buccal alignment body is removed, and which can aid in helping the practitioner know where the implant platform and abutment platform are located (even when hidden). Flowable composite, e.g., of a different color, can be placed into the rectangular box or other timing alignment structure to aid in identification of the buccal surface of the cuff and proper rotational alignment (“timing”) of the abutment with the implant.

### CROSS-REFERENCE TO RELATED APPLICATIONS

This application claims the benefit of and priority to U.S. Provisional Application No. 63/710,443, filed on October 22, 2024, entitled, “3D PRINTED OR OTHER ANATOMICAL AND CIRCULAR GINGIVAL CUFFS”, the entire contents of which is hereby incorporated by reference in its entirety.

Each of U.S. Patent Nos. 8,628,327; 9,572,640; 9,895,209; 10,016,260; 10,687,922; 10,470,856; 10,595,969; 10,695,152; 10,507,081; 10,709,525; 11,253,345; 11,478,339; 10,595,970; 11,571,283; 10,568,720; and 11,559,379 and U.S. Publication Nos. 2022/0151742 and 2022/0249206 and U.S. Application No. 63/557,379 filed February 23, 2024, entitled OMNI-ABUTMENT CORE AND METHODS OF USE, and U.S. Application No. 19/060,102 filed February 21, 2025, entitled OMNI-ABUTMENT CORE AND METHODS OF USE, and U.S. Application No. 63/567,706 filed March 20, 2024, entitled CT SCANNING OF INTRAORAL SOFT TISSUE AND DENTAL STRUCTURES, and PCT Application No. PCT/US25/20616 filed March 20, 2025, entitled CT SCANNING OF INTRAORAL SOFT TISSUE AND DENTAL STRUCTURES, is each herein incorporated by reference in its entirety.

### BACKGROUND OF THE INVENTION

### 1. The Field of the Invention

This invention relates to manufactured dental abutments and gingival healing cuffs used in any stage of oral surgery where a tooth is extracted or missing. Such an example of oral surgery includes first stage oral surgery, for example, when an implant is initially placed into a tooth void (e.g., whether the tooth is extracted or was congenitally or otherwise missing). The abutments and inventive gingival healing cuffs may also be used in any other dental surgery where it is desired to preserve the emergence profile of gingival tissue surrounding one or more teeth (e.g., second stage surgery, immediate or delayed implant placement, etc.).

### 2. The Relevant Technology

In modern dentistry, when one or more teeth are removed it is desirable to eventually replace the tooth or teeth with a prosthesis (e.g., a crown, bridge, etc.), although this is typically accomplished weeks later. Once the tooth is removed or missing, a dental implant is placed into the bone tissue of the jaw to provide a secure foundation upon which a prosthesis can be supported. Typically, the site is allowed to heal for a period of time prior to installation of the permanent prosthesis. Currently, a device known as a healing cap, abutment, or gingival healing cuff is coupled into the dental implant while the site is allowed to heal, to cap or cover the inside of the dental implant and to preserve the ability to re-access the dental implant once the site has sufficiently healed, when it is desired to install a prosthesis. Once the site has healed, the healing cap, abutment, or gingival healing cuff is removed, and a custom prosthesis (e.g., a crown) may be installed, supported by the dental implant anchored within the jaw bone.

While a variety of dental abutments and gingival healing cuffs are available within the art, including some configurations provided by applicant, there is still a continuing need for improved abutments and gingival healing cuffs that would provide additional features and functionality that is not currently available.

### SUMMARY

The present assemblies include an abutment and a gingival healing cuff surrounding the abutment. The abutment seats into and is configured for attachment into a dental implant. The abutment provides strength to the overall assembly, while the gingival healing cuff can be shaped and configured to preserve soft tissue and the emergence profile of such soft tissue for the given tooth position where placed. In an embodiment, the gingival healing cuff may be anatomical in shape, providing custom or substantially custom filling of the subgingival void where placed, so as to prevent or minimize slump, thinning, and or undesirable loss of the surrounding gingival soft tissue. In another embodiment, the gingival healing cuff may be provided in a more conventional round (e.g., circular or other non-anatomical shape when looking at the coronal profile), as many practitioners are more accustomed to using such a circular profiled gingival healing cuff, rather than an anatomically shaped gingival healing cuff, as described in many of Applicant’s earlier patent filings, already incorporated by reference.

By way of example, a kit or system of such assemblies may be provided, with different cuff geometries (e.g., anatomical or circular or other non-anatomic shape), and in different lengths (e.g., long – such as from about 8 to 12 mm, or about 10 mm, or short – such as from 4 to 6 mm, or about 5 mm), allowing a practitioner to choose desired gingival healing cuffs for desired particular tooth positions.

In many respects, the gingival healing cuffs and abutments may be similar to those described in Applicant’s earlier filings, already incorporated by reference, with a few additional very helpful features.

For example, in an embodiment, the gingival healing cuffs may be manufactured through additive manufacturing (3D printing). Alternative methods of fabrication are also possible, e.g., casting, injection molding, machining, or the like.

In an embodiment, the gingival healing cuff may include a rectangular or other shaped box or recess positioned in the buccal face of the gingival healing cuff. For example, such an alignment or “timing” aid may be positioned apically relative to any included buccal T-shaped handle or alignment structure. Such a rectangular box or other “timing aid” may be helpful for alignment (particularly “timing” alignment), especially once any initially included buccal T-shaped handle or alignment member is removed. Timing refers to the rotational orientation of the gingival healing cuff, e.g., relative to the abutment core, the underlying implant, and/or other adjacent structures, etc. Such a “timing” alignment structure may also be helpful for ascertaining the depth of the abutment platform (which is hidden within the assembly), and the implant platform, which is of course also hidden, once such structures are installed. For example, the abutment platform may be on a central portion of the abutment and may abut the apical bottom portion of the gingival healing cuff, when the coronal portion of the abutment is received into the gingival healing cuff. Such a box or other timing alignment structure on the gingival healing cuff may provide a visual reference, to allow the practitioner to know the depth of such structures, within the surgical site. Without such a box or other timing alignment structure, many practitioners will have difficulty knowing how far up or down any given structures (e.g., the abutment platform and the implant platform) actually are. Such a box or other timing alignment structure may be a wide aspect ratio rectangle (e.g., a horizontally oriented rectangle, with the long side of such rectangle being generally horizontal), although other shapes or markers are of course also possible. Such a box or other marker may be positioned apically below the buccal handle or T-shaped alignment member. Such a buccal box or similar marker can also be helpful in scanning (e.g. digital, CT or other) to ensure proper orientation of the gingival healing cuff and abutment assembly with the underlying implant and surrounding anatomical structure.

In an embodiment, any buccal and lingual alignment bodies, which provide function as a handle in addition to alignment and other benefits, may be fabricated so as to easily snap off the adjacent portion of the gingival healing cuff, from which they extend. For example, because these structures may be 3D printed, with the gingival healing cuff as a single integral piece of material, it is possible to fabricate such with a narrowed or reduced, easily breakable cross-section adjacent the exterior face of the gingival healing cuff. Previously, e.g., when casting such structures, it was difficult if not impossible to include undercuts in such structures, as it interferes with release from the casting jig. Such an undercut, thinned cross-sectional region as shown in the accompanying figures is advantageous, as the alignment body is easily broken off, rather than requiring a more labor intensive option of cutting off the alignment body. For example, application of simple moderate finger pressure on the alignment body may be sufficient to cause it to break away, once its purpose is complete. Once broken away, the resulting surface (which may be rough) is easily smoothed away by a quick simple touch with a dental bur.

The present assemblies may advantageously include an abutment that serves as a core to the assembly. The abutment may advantageously be formed from titanium or another biocompatible metal. The material of the abutment may be different (e.g., and stronger than) that of the surrounding gingival healing cuff. Other biocompatible materials (e.g., ceramic or polymer) are also possible for the abutment, although titanium and similar biocompatible metals provide a particularly strong anchor, for support of the adjacent gingival healing cuff, and any eventual crown, cusp, bridge, or other temporary or permanent dental prosthesis. Alternative abutment materials may often lack strength, particularly torque strength, the ability to torque test, and the like. Thus, in an embodiment, a titanium or similar high strength abutment is used. High strength 3D printable resin and other printable high strength materials (e.g., a metal 3D print) may also be suitable, particularly as such options become increasingly available and viable.

Thus in an embodiment, the assembly includes two separate pieces e.g., formed from two separate materials (e.g., a titanium or other high strength abutment, surrounded by a 3D resin printed gingival healing cuff). Such a gingival healing cuff may be printed from an FDA approved resin material, such as OnX Tough 2, available from SprintRay. OnX Tough 2 is believed to be a proprietary photopolymer resin, including a mixture of methacrylic acid esters, photoinitiators, pigment(s) and additives. Other suitable biocompatible materials may be apparent to those of skill in the art, and are within the scope of the present disclosure.

The buccal and lingual alignment bodies may be formed from a less expensive material, e.g., not necessarily FDA approved, as these structures do not remain in place in the mouth, but are removed during the initial placement procedure. For example, some 3D printers may have the capability to print two different materials sequentially, or even at the same time. In another alternative, such alignment bodies could of course also be added later, in a separate step (e.g., whether 3D printed or otherwise formed).

In an embodiment, the gingival healing cuffs may be provided in a manner that they include internal geometry that mates with the exterior geometry of the abutment. Such abutment may be the core, that the gingival healing cuff fits over, and around. Such abutment (as well as the apical recess of the gingival healing cuff) may include a transverse cross-sectional geometry (perpendicular/normal to the longitudinal axis of the abutment and gingival healing cuff) that includes one or more flat faces, with a curved or rounded face connected to such flat face, so as to provide a closed geometric shape, that ensures proper alignment with the gingival healing cuff placed thereover. For example, the abutment may provide one or two flat faces. A keyed arrangement that provides only a single instance of proper alignment between the two structures (gingival healing cuff and abutment) may be advantageous. The gingival healing cuff may be provided in both short (e.g., 4-6 mm, such as about 5 mm in length) and long (e.g., 8-12 mm, such as about 10 mm in length) configurations. The gingival healing cuff may also be provided in both an anatomical shape, providing anatomical filling of the subgingival void adjacent the emergence profile of a given tooth position. The gingival healing cuff may also be provided in circular or other non-anatomical shapes (when viewing the coronal profile), which are not anatomical, but to which many practitioners are accustomed to using.

Advantageously, because the gingival healing cuffs are formed from a 3D printed resin material, they can easily be further customized, by adding thereto (e.g., using a curable flowable composite) or removing portions therefrom (e.g., easily removed using a dental bur, as they are not metallic). Metal gingival healing cuff materials do not provide such benefits. For example, while many dental suppliers provide gingival healing cuffs formed (e.g., entirely) from titanium, there is no reason to use such, ever.

The abutment may be any of a wide variety of commercially available abutments, either available from Applicant, or a wide variety of other suppliers. The manufacturer, or the practitioner may assemble the assembly by placing the provided gingival healing cuff over the abutment, aligning the internal geometry of the hollow gingival healing cuff with that of the abutment, fitting the one over the other. A flowable composite or other bonding material may be used to adhere the two structures together, e.g., by placing such flowable composite or other bonding material onto one or both of the abutment surface and the gingival healing cuff surface that are to be mated together. The two structures may then be secured to one another by simply exposing the assembly to a dental curing light (e.g., UV light, of curing wavelengths, such as less than 450 nm, such as about 350 to about 400 nm). Such a flowable composite is an improved alternative to a bis-acrylic resin, which while works, does not provide as strong a bond as is achieved with such a flowable composite. An example of a suitable flowable composite is GrandioSO light flow, available from Voco Dental, which is a dental filling material, including 10-25% by weight 1,6-hexanediylbismethacrylate, 2.5-5% aliphatic dimethacrylate(s), 2.5-5% BISGMA, 2.5-5% triethylene glycol dimethacrylate, and a major fraction (e.g., as much as 70-80%) filler. In another embodiment, it may be advantageous to use a bonding medium that would allow for micro mobility between the abutment and the gingival healing cuff; e.g., reducing forces being applied to the implant. A wide variety of bonding mediums, cements, flowable dental composites and the like may be suitable for use.

The top (coronal) face of the gingival healing cuff may advantageously include a hex shaped opening. Such an opening allows insertion of a hex tool into the top of the gingival healing cuff, and torque testing of the assembly and associated dental implant. Other shaped openings may also be possible, e.g., so long as they similarly allow for such similar benefits.

While typical commercial abutments are often provided with a length of 10-12 mm, the abutment included in the present assemblies may be shorter, e.g., such as no more than about 7 mm, no more than 5 mm, no more than 4 mm, no more than about 3 mm, such as from about 3 mm to about 7 mm, or from about 2.5 mm to about 4 mm in length. Such abutments may be cut to such shorter length, or may be formed to such length during initial manufacture, particularly where provided by Applicant, rather than using commercially available abutments for the core portion of the assembly.

In an embodiment, the abutment may include a generally horizontal groove or recess on the abutment. The horizontal groove on the titanium abutments may primarily be to assist in retention of the prosthetic while vertical walls are to help prevent rotation of the prosthetic placed on the abutment. With both the vertical walls along with the horizontal grooves, there is presumed to be stability of the overlying prosthetic. However, it should be noted that Applicant has included in the interior surface of the gingival healing cuff, features to allow the gingival healing cuff to seat along the vertical walls to allow for correct alignment of the gingival healing cuff in relation to the implant abutment and rotational timing (i.e., rotational orientation) with the implant. Applicant has also provided other features (e.g., vertical recess boxes with dovetail grooves and/or other retentive structures) embedded in the internal walls of the abutment receiving area of the gingival healing cuff (the apical recess of the gingival healing cuff) to allow flowable composite or other bonding material to enter into and when cured to allow for a tight bond with the titanium or other abutment, all while accounting for the polymerization shrinkage of the composite resin or other bonding material. The particular internal geometry provided within the gingival healing cuff has required significant effort to overcome problems associated with shrinkage of the composite or other bonding material and ensure a stable, strong and predictable bond with the abutment. In addition, Applicant has been not only modifying the height of the abutments (e.g., cut them down to about 2.5 to 4 mm), but has been placing a plurality (e.g., two) divots (e.g., with a bur) on the sides of the abutments to assist in additional retention.

In any of the described embodiments, the assembly may include a plurality of available gingival healing cuffs, each with a different size or configuration, wherein each gingival healing cuff includes a hollow opening in the apical face, at a center portion of the gingival healing cuff, for receipt of the coronal superstructure portion and geometry of the abutment, above the abutment platform. In an embodiment, the apical hollow opening in each gingival healing cuff is identically sized. In another embodiment, the apical hollow openings can be of different sizes and/or shapes, e.g., on gingival healing cuffs that are of different shapes so they could fit over the abutments if they were of different sizes, or mating shapes. As noted previously, the internal mating geometry of the gingival healing cuff may include a keyed arrangement relative to the abutment to be received therein. Such a keyed arrangement may not permit relative rotation of the two structures, once coupled together, and may allow insertion of the abutment into the gingival healing cuff with only a single rotational arrangement between the two structures, to ensure proper alignment.

In any of the described embodiments, the gingival healing cuff may include at least one of a buccal or lingual handle portion or alignment body extending from the gingival healing cuff. In another embodiment, no such handle(s) are provided. The provided rectangular box or other timing alignment structure provided on the buccal surface is also helpful in ensuring the practitioner knows the proper orientation of the assembly, including depth of the apical platform where abutment (seating) of the gingival healing cuff platform on the implant platform occurs. The buccal rectangular box or other timing alignment structure also assists the surgeon in determining the depth of the implant and abutment platform in relationship to the gingival zenith, thus allowing for establishment for an ideal soft tissue emergence profile.

In any of the described embodiments, the coronal portion of the abutment coronally above the abutment platform can include one or more recessed portions in an exterior periphery of the abutment, for reception of a flowable composite or other bonding material for adhering the abutment to an associated gingival healing cuff. Similarly, such recessed portions could be provided in the interior periphery of the gingival healing cuff, within the apical recess configured to receive the coronal portion of the abutment. In either case, the recessed portion(s) provide space for the flowable composite or other bonding material, to be located, and adhere the two structures together.

Similarly, the gingival healing cuff may include one or more injection ports (e.g., small holes on mesial and/or distal ends of the gingival healing cuff). The practitioner may apply a drop of composite or other bonding material at one or more locations on the side(s) of the gingival healing cuff, and a drop of composite or other bonding material on the abutment. Providing such injection ports in the gingival healing cuff, allows one to inject composite or other bonding material, having it flow within and around the recessed portion(s) noted above, and flow out the other injection hole port. Ideally, placement of injection ports into the gingival healing cuff body better facilitates bonding of the abutment and gingival healing cuff together, e.g., by use of biocompatible injectable composite or other bonding material. Similar structure could be used for attaching a crown, cusp, bridge or other prosthetic over the gingival healing cuff body or directly to an abutment in the case of a final prosthesis. In addition, the use of injection ports as described herein makes the process of bonding the abutment and the gingival healing cuff easier that with other techniques.

In any of the described embodiments, even if the abutment is formed of a material that is not transparent to UV curing light wavelengths (e.g., titanium), the degree of transparency of the gingival healing cuff structure may be sufficient for UV light to pass through the gingival healing cuff, to cure material present in any provided recesses, etc., to effectively adhere the two structures together.

In another embodiment, even if the abutment is not formed of a material that is transparent to UV curing light wavelengths (e.g., such as titanium, zirconium, titania, zirconia, etc.), UV curing of a given composite or other desired curable or bonding material used for bonding two structures together (e.g., the abutment and a gingival healing cuff) may still be possible by providing perforations through such abutment, to allow transmission of UV curing light wavelengths therethrough.

The gingival healing cuffs and/or abutments may include any of various scanning features, e.g., as described in U.S. Application No. 19/060,102 filed February 21, 2025, entitled OMNI-ABUTMENT CORE AND METHODS OF USE, and U.S. Application No. 63/567,706 filed March 20, 2024, entitled CT SCANNING OF INTRAORAL SOFT TISSUE AND DENTAL STRUCTURES, and PCT Application No. PCT/US25/20616 filed March 20, 2025, entitled CT SCANNING OF INTRAORAL SOFT TISSUE AND DENTAL STRUCTURES, each of which is herein incorporated by reference. By way of example, the rectangular or other shaped timing alignment structure positioned apical to the T-shaped alignment body or handle is an example of such a feature, which aids in determining orientation of the gingival healing cuff body, and any attached structures, within a CT or similar scan.

Another example of such external periphery placed structures that would aid in determining orientation when scanning would be the placement of small dots or other markers (e.g., protrusions, recesses, or even just placement of something with a color contrast) on the outside peripheral surface of the gingival healing cuff, that would help the scanner pick up the geometry better. Such features could be provided during manufacture or added by the practitioner chairside, because of the shapable nature of the gingival healing cuff. Ideally, such features used for aiding in orientation within a captured scan would be positioned on any of the side surfaces (mesial, distal, lingual, or buccal, or the coronal (top) surface).

Older scanners in particular do not pick up such details and features as well. For example, Applicant has sometimes drawn various differing shapes (e.g., a circle, square, & triangle (penciled in), so that the scanner would capture that, aiding in later determination of correct orientation of the captured scan. By way of example, some scanners can pick up not only shape/size differences, but also capture color contrast differences (e.g., resulting from penciling in identifying shapes/markers on various faces). For example, depending on the type of material the gingival healing cuff is made from, e.g., a relatively radiodense material, such markers in or on the gingival healing cuff can be picked up by a CT or other scanner. In addition, Applicant recognizes that scanners will continue to improve, providing even better resolution and differentiation between various materials, interfaces, and geometry in the near future. By way of further example, such exemplary described features may relate to digital scanning and possibly photogrammetry.

In an embodiment, the gingival healing cuff may be specifically configured to provide for soft tissue adherence, e.g., as described in Applicant’s U.S. Patent Nos. 10,595,970 and 11,571,283, each of which is herein incorporated by reference in its entirety. Such soft tissue adherence provides a seal around the gingival healing cuff (particular when anatomically shaped), reduces or prevents ingress of pathogenic microbes between the gingival healing cuff and the soft tissue, and/or reduces or prevents recession of the soft tissue around the gingival healing cuff.

An exemplary embodiment is directed to an assembly comprising (i) an abutment formed from a ceramic or metal material or a polymer having a minimum desired tensile strength, and (ii) a gingival healing cuff, wherein the gingival healing cuff fits over the abutment, wherein the gingival healing cuff includes an internal shape and geometry that mates with an exterior transverse cross-sectional shape of the abutment, wherein the exterior transverse cross-sectional shape of the abutment is a closed shape including a curved face, and one or more flat faces.

In any of the described embodiments, the abutment may comprise titanium, zirconium, another metal, or a ceramic.

In any of the described embodiments, the abutment may comprise at least one of a 3D printable resin material, other 3D printable material (e.g., 3D printable metal), or a castable material (e.g., polyether ether ketone (PEEK)).

In any of the described embodiments, the gingival healing cuff may comprise a 3D printable resin material or other material which is readily shapable so that a user can remove material from, or add material to the gingival healing cuff.

Another embodiment is directed to a system including a plurality of assemblies as described herein, wherein the system includes a plurality of available gingival healing cuffs, each with a different size or configuration, available in different lengths, wherein each gingival healing cuff includes a hollow opening at a center portion of the gingival healing cuff, for receipt of an external surface structure of the abutment, wherein the hollow opening in each gingival healing cuff of the system is identically sized, or wherein the hollow openings are made to fit over specific abutment sizes and/or configurations.

In any of the described embodiments, such a system may include a plurality of assemblies, wherein the system may include a plurality of available gingival healing cuffs, selected from the following:

(a) shaped and short- including a plurality of available gingival healing cuffs, each of a different shape for a particular tooth position, provided with anatomical shapes to provide anatomical filling of an emergence portion of a subgingival void of a given tooth position, each of the gingival healing cuffs having a length from 3 to 7 mm;

(b) shaped and long - including a plurality of available gingival healing cuffs, each of a different shape for a particular tooth position, provided with anatomical shapes to provide anatomical filling of an emergence portion of a subgingival void of a given tooth position, each of the gingival healing cuffs having a length from 8 to 12 mm;

(c) circular and short- including a plurality of available gingival healing cuffs, each of a different size for a particular tooth position, provided with a circular coronal profile, each of the gingival healing cuffs having a length from 3 to 7 mm;

(d) circular and long - including a plurality of available gingival healing cuffs, each of a different size for a particular tooth position, provided with a circular coronal profile, each of the gingival healing cuffs having a length from 8 to 12 mm.

In any of the described embodiments, the system may include a plurality of available gingival healing cuffs, available in at least 9 anatomical shapes selected from maxillary molar, maxillary premolar, maxillary canine, maxillary lateral incisor, maxillary central incisor, mandibular incisor, mandibular canine, mandibular premolar, mandibular molar, primary maxillary molar, and/or primary mandibular molar.

In any of the described embodiments, the assembly may further include at least one of a buccal alignment body or lingual alignment body extending from the gingival healing cuff.

In any of the described embodiments, the gingival healing cuff may further include a rectangular box or other timing alignment structure positioned apical to the buccal alignment body.

In any of the described embodiments, the rectangular box or other timing alignment structure may be configured as a horizontal box recessed into a peripheral face of the gingival healing cuff, wherein the horizontal box is positioned apical to the buccal alignment body.

In any of the described embodiments, the buccal alignment body or lingual alignment body may include a portion of reduced cross-sectional thickness adjacent a proximal end of the buccal alignment body or lingual alignment body, to facilitate break away by a practitioner once the buccal alignment body or lingual alignment body is no longer needed.

In any of the described embodiments, the gingival healing cuff may include a hexagonal or other shaped opening in a coronal face of the gingival healing cuff to allow for in-situ torque testing of the assembly and an associated implant.

In any of the described embodiments, the interior of the gingival healing cuff may include internal structure where the gingival healing cuff attaches to the abutment that allows for securing the abutment and the gingival healing cuff together, including compensation of polymerization shrinkage of a composite or other bonding material used to attach the gingival healing cuff to the abutment.

In any of the described embodiments, the abutment may be formed of a material that is transparent to UV curing light wavelengths, such that UV light positioned in a hollow core of the abutment passes through portions of a core wall of the abutment to assist in curing composite or other bonding materials used to attach the gingival healing cuff or other device to the abutment.

In any of the described embodiments, the abutment may be formed of a material that is not transparent to UV curing light wavelengths, the abutment further comprising perforations configured to allow transmission of UV curing light wavelengths therethrough, such that UV light positioned in a hollow core of the abutment passes through such perforations of a core wall defining the hollow core to assist in curing composite or other bonding materials used to connect the gingival healing cuff or other device to the abutment.

Another embodiment is directed to a method of use comprising: providing an abutment formed from a ceramic or metal material or a polymer having a minimum desired tensile strength (e.g., at least about 90 MPa); providing a gingival healing cuff, wherein the gingival healing cuff fits over the abutment, wherein the gingival healing cuff includes an internal shape and geometry that mates with an exterior transverse cross-sectional shape of the abutment, wherein the exterior transverse cross-sectional shape of the abutment is a closed shape including a curved face, and one or more flat faces; and applying a composite or other bonding material to an exterior of the abutment and/or interior of the gingival healing cuff and positioning the gingival healing cuff over the abutment, and securing the gingival healing cuff over the abutment.

In any of the described embodiments, the method may further include providing or forming one or more indentations into exterior faces of the abutment for reception of composite or other bonding material, to provide additional retention when securing the gingival healing cuff over the abutment.

In any of the described methods or other embodiments, the gingival healing cuff may include a rectangular box or other timing alignment structure positioned apical to a buccal alignment body, wherein the rectangular box or other timing alignment structure is configured as a horizontally oriented rectangular box recessed into a peripheral buccal face of the gingival healing cuff, apical to the buccal alignment body, and the method may further include applying a composite or other bonding material into the horizontally oriented rectangular box, wherein the applied composite or other bonding material has a contrasting color as compared to surrounding structures, to aid a practitioner in recognizing proper orientation of the abutment and gingival healing cuff. Such a material applied to such area may have a radiopacity that differs from the adjacent gingival healing cuff material, so as to show up on a CT or other digital scan.

In any of the described methods or other embodiments, the gingival healing cuff may include a hexagonal or other shaped opening in a coronal face of the gingival healing cuff to allow for in-situ torque testing of the abutment, gingival healing cuff and an associated implant, and the method may further include inserting a torque wrench or other tool for testing torque into the hexagonal or other shaped opening, to test torque of an underlying implant.

In any of the described embodiments, the method may further include attaching a crown, cusp, bridge or other prosthesis over the gingival healing cuff.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures.

FIGS. 1-2 illustrate isometric views of an exemplary gingival healing cuff according to an embodiment of the present disclosure. By way of example, the exemplary gingival healing cuff shown in FIGS. 1-2 may be described as a round (non-anatomic) and short gingival healing cuff that can be used in any tooth position as desired by the practitioner.

FIG. 3 illustrates a cross-sectional view through the gingival healing cuff of FIGS. 1-2.

FIGS. 4-8 illustrate a side view, an apical bottom view, a coronal top view, and buccal and lingual side views, respectively of the gingival healing cuff of FIGS. 1-2.

FIGS. 9-10 illustrate isometric views of another exemplary gingival healing cuff according to an embodiment of the present disclosure. By way of example, the exemplary gingival healing cuff shown in FIGS. 9-10 may also be described as a round (non-anatomic) and short gingival healing cuff that can be used in any tooth position as desired by the practitioner.

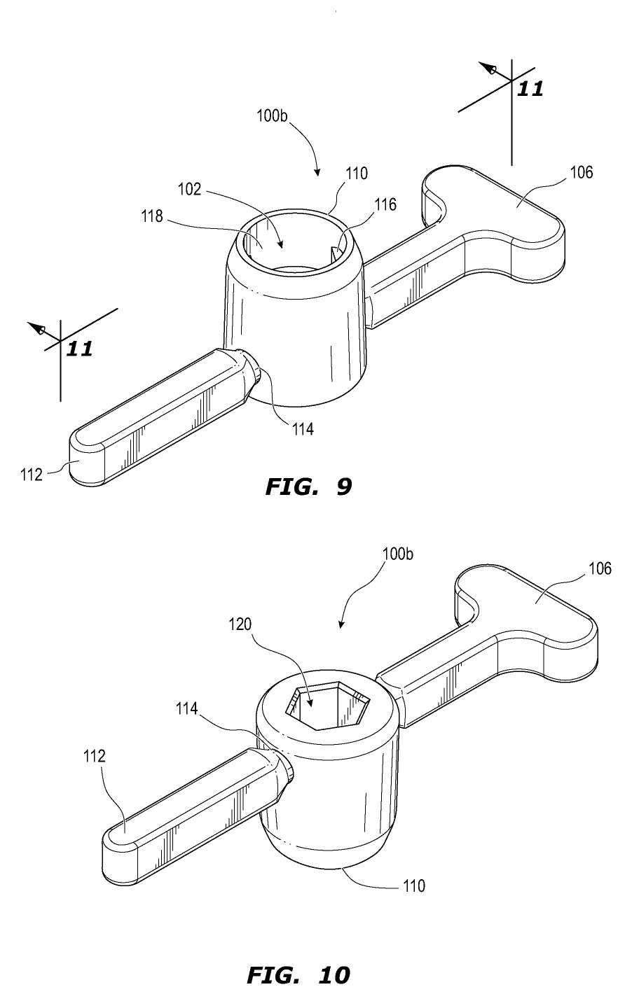

FIG. 11 illustrates a cross-sectional view through the gingival healing cuff of FIGS. 9-10.

FIGS. 12-16 illustrate a side view, an apical bottom view, a coronal top view, and buccal and lingual side views, respectively of the gingival healing cuff of FIGS. 9-10.

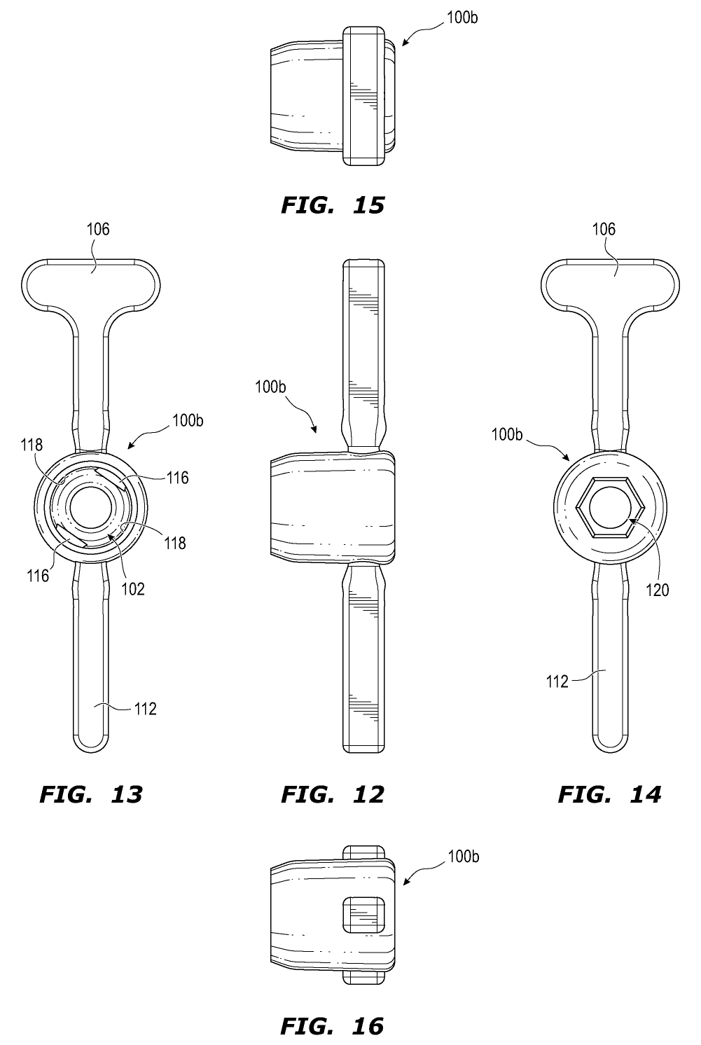

FIGS. 17-18 illustrate isometric views of another exemplary gingival healing cuff according to an embodiment of the present disclosure. By way of example, the exemplary gingival healing cuff shown in FIGS. 17-18 may be described as a round (non-anatomic) and long gingival healing cuff that can be used in any tooth position as desired by the practitioner. Because of its size, a practitioner may typically employ such a gingival healing cuff in a molar tooth position.

FIG. 19 illustrates a cross-sectional view through the gingival healing cuff of FIGS. 17-18.

FIGS. 20-24 illustrate a side view, an apical bottom view, a coronal top view, and lingual and buccal side views, respectively of a gingival healing cuff similar to that of FIGS. 17-18, but which may be described as shaped (anatomical) and long, e.g., for use in a lower molar tooth position.

FIGS. 25-26 illustrate isometric views of another exemplary gingival healing cuff according to an embodiment of the present disclosure. By way of example, the exemplary gingival healing cuff shown in FIGS. 25-26 may be described as a shaped (anatomic) and short gingival healing cuff specifically configured for use in a lower molar tooth position.

FIG. 27 illustrates a cross-sectional view through the gingival healing cuff of FIGS. 25-26.

FIGS. 28-32 illustrate a side view, an apical bottom view, a coronal top view, and lingual and buccal side views, respectively of the gingival healing cuff of FIGS. 25-26.

FIGS. 33A-33B illustrate another exemplary gingival healing cuff, shown mated over an exemplary abutment.

### DETAILED DESCRIPTION OF THE PREFERRED EMBODIMENTS

### I. Definitions

Some ranges may be disclosed herein. Additional ranges may be defined between any values disclosed herein as being exemplary of a particular parameter. All such ranges are contemplated and within the scope of the present disclosure.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values for example thus include values that are within 20%, 10%, within 5%, within 1%, etc. of a stated value.

All numbers used in the specification and claims are to be understood as being modified in all instances by the term “about”, unless otherwise indicated. The use of “about”, “substantially” and the like may particularly include values within the above stated variance (e.g., within 20%, 10%, 5%, 1%). Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

It must be noted that, as used in this specification and the appended claims, the singular forms “a,” “an” and “the” include plural referents unless the content clearly dictates otherwise.

Any directions or reference frames in the description are merely relative directions (or movements). For example, any references to “top”, “bottom”, “up” “down”, “above”, “below” or the like are merely descriptive of the relative position or movement of the related elements as shown, and it will be understood that these may change as the structure is rotated, moved, the perspective changes, etc.

All publications, patents and patent applications cited herein, whether supra or infra, are hereby incorporated by reference in their entirety to the same extent as if each individual publication, patent or patent application was specifically and individually indicated to be incorporated by reference.

### II. Introduction

In one embodiment, the present disclosure is directed to an assembly that includes an abutment and a gingival healing cuff. The gingival healing cuff fits over the abutment, wherein the gingival healing cuff includes an internal shape and geometry that mates with the exterior transverse cross-sectional shape (e.g., a closed shape with a curved face, and one or more flat faces) of the abutment. The various structures provided in the gingival healing cuffs and assemblies as shown in the accompanying Figures provide functionality not available in current systems.

### III. Exemplary Methods and Systems

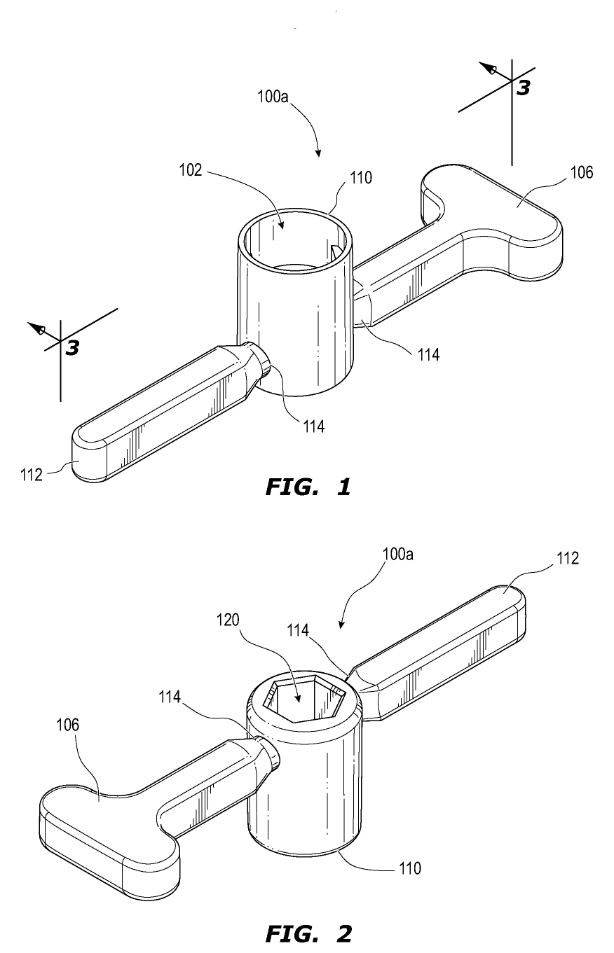

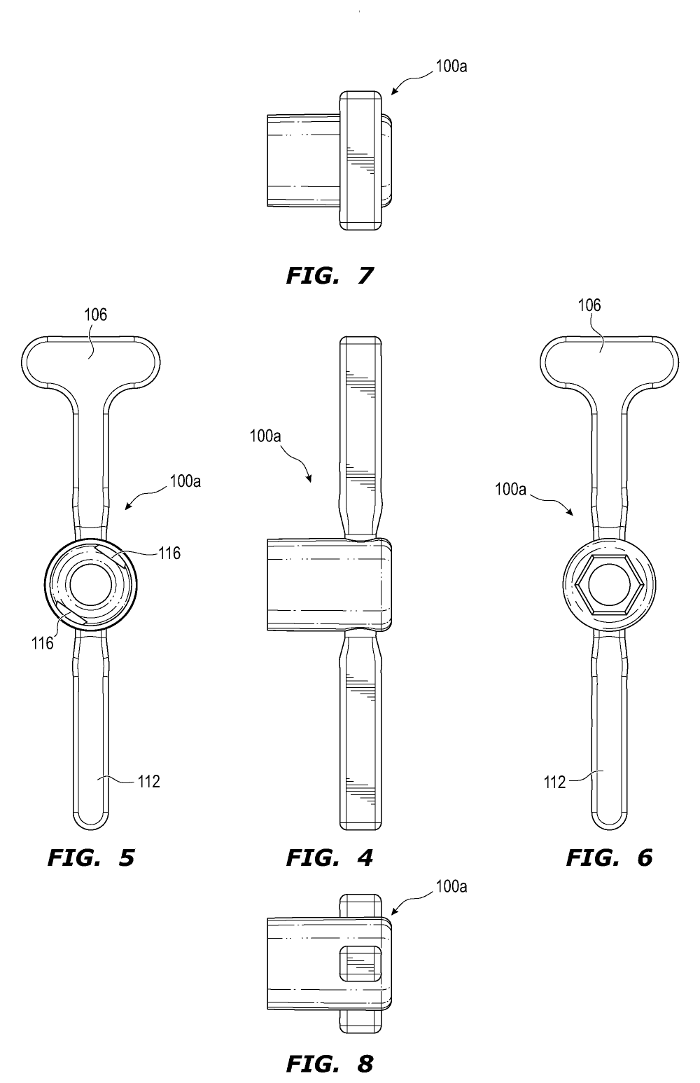

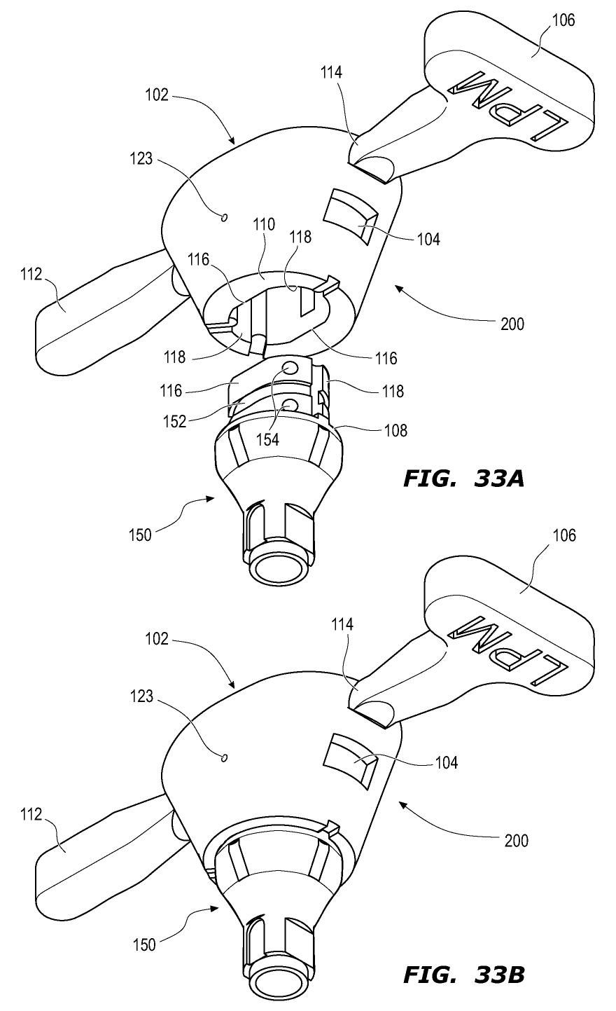

Referring to FIGS. 1-8, an exemplary gingival healing cuff 100a is shown. Such a gingival healing cuff includes a circular coronal profile. By way of example, the exemplary gingival healing cuff 100a may be described as a round (non-anatomic) and short gingival healing cuff that can be used in any tooth position as desired by the practitioner. Gingival healing cuff 100a includes an apical opening or recess 102 configured to receive and mate with a received abutment (not shown). The abutment seats into and is configured for attachment into a dental implant (not shown). The abutment provides strength to the overall assembly, while the gingival healing cuff 100a can be shaped and configured to preserve soft tissue and the emergence profile of such soft tissue for the given tooth position where placed. In an embodiment, the particular illustrated gingival healing cuff 100a is provided with a conventional round coronal profile (e.g., circular or other non-anatomical shape), as many practitioners are more accustomed to using such a circular profiled gingival healing cuff, rather than an anatomically shaped gingival healing cuff. As will be appreciated, and as shown in FIGS. 33A-33B, the external peripheral shape of the gingival healing cuff may be anatomical in shape, providing custom or substantially custom filling of the subgingival void where placed, so as to prevent or minimize slump, thinning, and or undesirable loss of the surrounding gingival soft tissue. Examples of such anatomical shapes will be familiar to those of skill in the art, many of which are shown in Applicant’s earlier patent filings, already incorporated by reference. For example, in an embodiment the system may include a plurality of available gingival healing cuffs, available in up to 11 anatomical shapes, including maxillary molar, maxillary premolar, maxillary canine, maxillary lateral incisor, maxillary central incisor, mandibular incisor, mandibular canine, mandibular premolar, mandibular molar, primary maxillary molar, and/or primary mandibular molar. By way of example, a system or kit may provide at least 9 of the above 11 shapes, or all 11 of the above shapes. Simpler kits or systems including fewer of such shapes are also possible.

In an embodiment, the gingival healing cuff 100a may be manufactured through additive manufacturing (3D printing). Alternative methods of fabrication are also possible, e.g., casting, injection molding, machining, or the like.

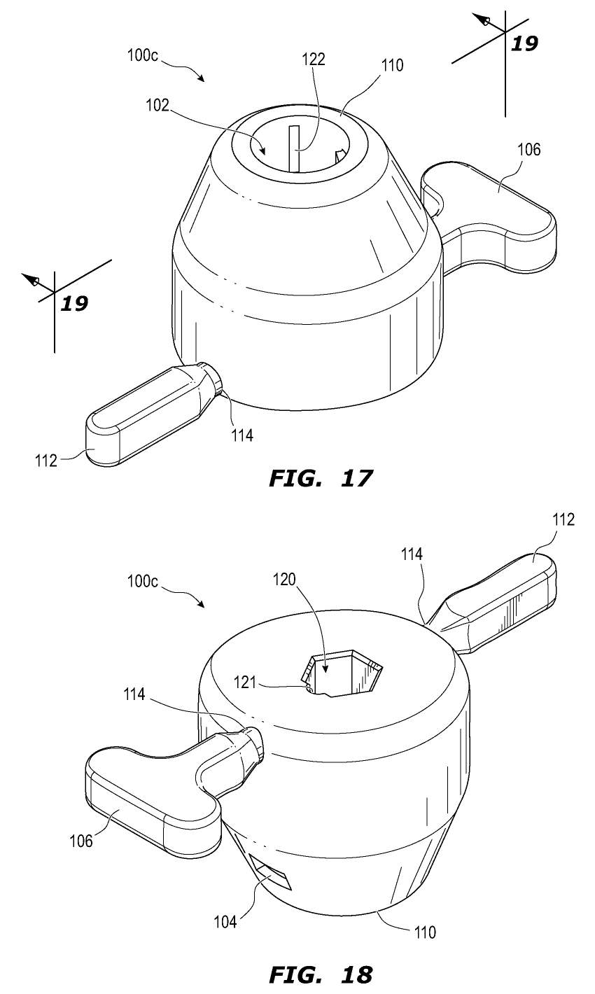

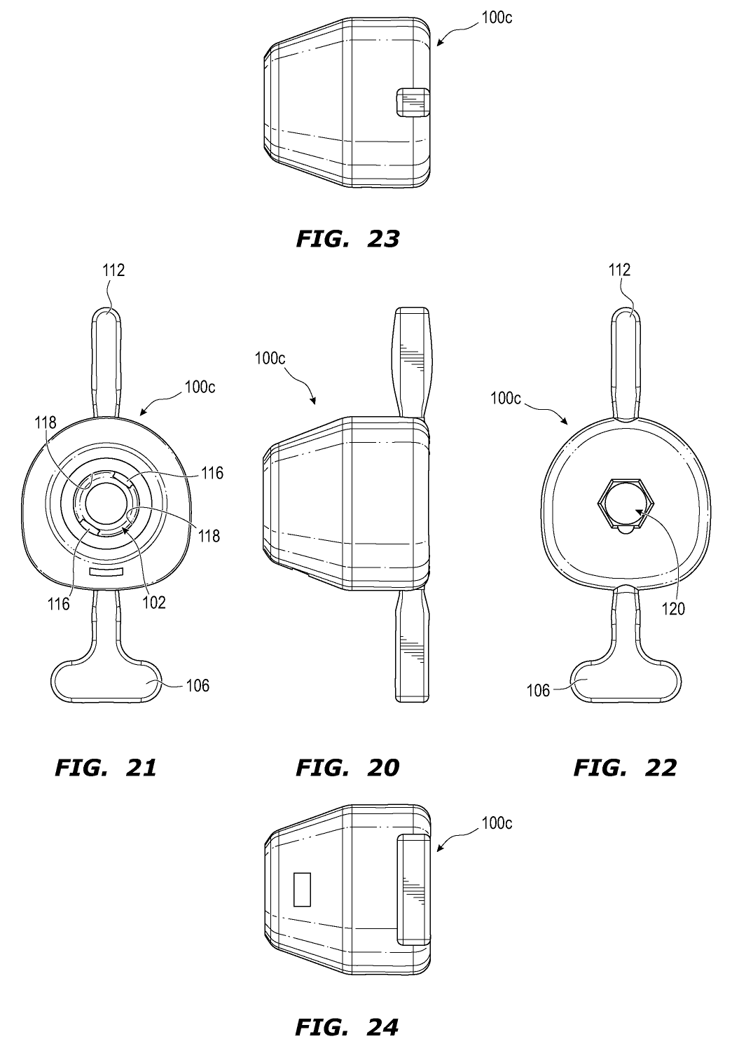

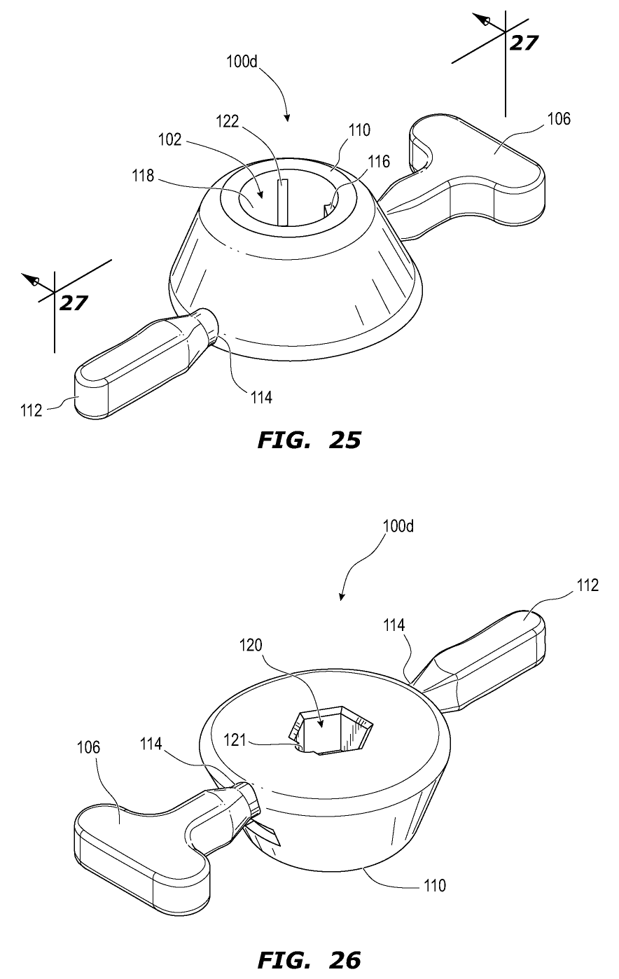

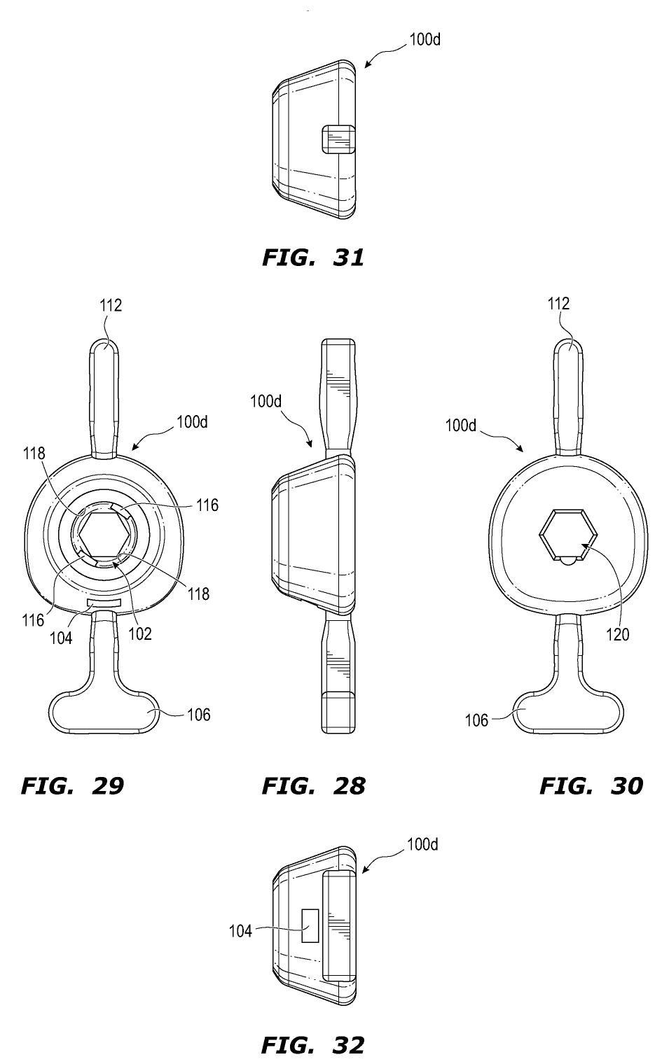

While not shown in FIGS. 1-8, in an embodiment, the gingival healing cuff may include a rectangular or other shaped box or recess 104 positioned in the buccal face of the gingival healing cuff. Examples of such embodiments are shown in FIGS. 17-24 (gingival healing cuff 100c) and FIGS. 25-32 (gingival healing cuff 100d). For example, such an alignment or “timing” aid structure 104 may be positioned apically relative to any included buccal T-shaped handle 106 or other alignment structure. Such a rectangular box or other “timing aid” 104 may be helpful for alignment (particularly “timing” alignment), especially once any initially included buccal T-shaped handle 106 or similar alignment member is removed. Timing refers to the rotational orientation of the gingival healing cuff, e.g., relative to the abutment core, the underlying implant, and/or other adjacent structures, etc. Such a “timing” alignment structure may also be helpful for ascertaining the depth of the abutment platform 108 (which is hidden within the assembly – see FIGS. 33A-33B), and the implant platform. For example, the abutment platform 108 may be on a central portion of the abutment and may abut the apical bottom portion 110 of the gingival healing cuff. Such a box or other timing alignment structure 104 may provide a visual reference, to allow the practitioner to know the depth of such structures (e.g., platform 108, surface 110 or the platform of the implant into which the abutment is seated, within the surgical site). By way of example, the practitioner may be informed that the bottom of the timing alignment structure 104 is a given number of millimeters coronally above the abutment platform 108 (e.g., 2 mm, 3 mm, 4 mm, 5 mm or the like). Without such a box or other timing alignment structure 104, many practitioners will have difficulty knowing how far up or down any given structures (e.g., the abutment platform 108 and the implant platform) actually are. Such a box or other timing alignment structure 104 may be a wide aspect ratio rectangle (e.g., a horizontally oriented rectangle, with the long side of such rectangle being generally horizontal) as shown in FIGS. 18 and 26, although other shapes or markers are of course also possible. Such a box or other marker 104 may be positioned apically below the buccal handle or T-shaped alignment member 106, as shown.

In an embodiment, the buccal alignment body 106 and lingual alignment body 112, which provide function as handles in addition to alignment and other benefits, may be fabricated so as to easily snap off the adjacent portion of the gingival healing cuff, from which they extend. For example, because these structures may be 3D printed, with the gingival healing cuff as a single integral piece of material, it is possible to fabricate such with a narrowed or reduced, easily breakable cross-section 114 adjacent the exterior face of the gingival healing cuff, as shown. Previously, e.g., when casting such structures, it was difficult if not impossible to include undercuts in such structures, as it interferes with release from the casting jig. Such an undercut, thinned cross-sectional region 114 as shown is advantageous, as the alignment body 106, 112 is easily broken off, rather than requiring a more labor intensive option of cutting off the alignment body 106, 112. For example, application of simple moderate finger pressure on the alignment body 106, 112 may be sufficient to cause it to break away, once its purpose is complete. Once broken away, the resulting surface (which may be rough) is easily smoothed away by a quick simple touch with a dental bur.

The present assemblies may advantageously include an abutment that serves as a core to the assembly. FIGS. 33A-33B shows an example of such an exemplary abutment 150. Various additional exemplary abutments are shown and described in U.S. Application No. 63/557,379 filed February 23, 2024, entitled OMNI-ABUTMENT CORE AND METHODS OF USE, and U.S. Application No. 19/060,102 filed February 21, 2025, entitled OMNI-ABUTMENT CORE AND METHODS OF USE. Numerous other abutments are of course also possible. The abutment may advantageously be formed from titanium or another biocompatible metal. Other biocompatible materials (e.g., ceramic or polymer) are also possible, although titanium and similar biocompatible metals provide a particularly strong anchor, for support of the adjacent gingival healing cuff, and any eventual crown, cusp, bridge, or other temporary or permanent dental prosthesis. Alternative abutment materials may often lack strength, particularly torque strength, the ability to torque test, and the like. Thus, in an embodiment, a titanium or similar high strength abutment is used. High strength 3D printable resin and other printable high strength materials (e.g., a metal 3D print) may also be suitable, particularly as such options become increasingly available and viable. By way of example, a polyether ether ketone (PEEK) or other high strength polymer may potentially be used, e.g., having a tensile strength of at least about 50 MPa, at least about 60 MPa, at least about 70 MPa, at least about 80 MPa, or at least about 90 MPa. That said, in some circumstances, one may specifically want to use a weaker abutment, e.g., where it is desired that the abutment break free so as to not overload an implant that has been immediately placed.

Thus in an embodiment, the assembly includes two separate pieces e.g., formed from two separate materials (e.g., a titanium or other high strength abutment, surrounded by a 3D resin printed gingival healing cuff). Such a gingival healing cuff may be printed from an FDA approved resin material, such as OnX Tough 2, available from SprintRay. OnX Tough 2 is believed to be a proprietary photopolymer resin, including a mixture of methacrylic acid esters, photoinitiators, pigment(s) and additives. Other suitable biocompatible materials may be apparent to those of skill in the art, and are within the scope of the present disclosure.

The alignment bodies (buccal and/or lingual) 106, 112 may be formed from a less expensive material, e.g., not necessarily FDA approved, as these structures do not remain in place in the mouth, but are removed during the initial placement procedure. For example, some 3D printers may have the capability to print two different materials sequentially, or even at the same time. In another alternative, such alignment bodies could of course also be added later, in a separate step (e.g., whether 3D printed or otherwise formed).

In an embodiment, the gingival healing cuffs may be provided in a manner that they include particular internal geometry that mates with the exterior geometry of the abutment. Such abutment 150 may be the core, that the gingival healing cuff (e.g., gingival healing cuff 200 in FIGS. 33A-33B) fits over, and around. As shown in FIGS. 33A-33B, such abutment 150 and the corresponding apical opening or recess 102 of the gingival healing cuff may include a transverse cross-sectional geometry (perpendicular/normal to the longitudinal axis of the abutment and gingival healing cuff) that includes one or more flat faces 116, with a curved or rounded face 118 connected to such flat face 116, so as to provide a closed geometric shape, that ensures proper alignment between the abutment, and the gingival healing cuff placed thereover. For example, the abutment may provide one or two flat faces 116, with the abutment providing corresponding sized and shaped flat surfaces 116, for keyed receipt of the abutment.

As noted, a kit may provide various gingival healing cuffs, where the gingival healing cuff may be provided in both short (e.g., 4-6 mm, such as about 5 mm in length) and long (e.g., 8-12 mm, such as about 10 mm in length) configurations, allowing a practitioner to choose which they prefer for a given application. The gingival healing cuff may also be provided in both an anatomical shape (as shown by gingival healing cuffs 100c and 100d in FIGS. 21, 29), providing anatomical filling of the subgingival void adjacent the emergence profile of a given tooth position. The gingival healing cuff may also be provided in circular or other non-anatomical shapes, which are not anatomical, but to which many practitioners are accustomed to using. Examples of such gingival healing cuffs including a circular coronal profile are shown in FIGS. 5 and 13.

Advantageously, where the gingival healing cuffs are formed from a 3D printed resin material, they can easily be further customized, by adding thereto (e.g., using a curable flowable composite) or removing portions therefrom (e.g., easily removed using a dental bur, as they are not metallic). Metal gingival healing cuff materials do not provide such benefits. For example, while many dental suppliers provide gingival healing cuffs formed (e.g., entirely) from titanium, there is no reason to use such, ever.

The abutment may be any of a wide variety of commercially available abutments, either available from Applicant, or a wide variety of other suppliers. The manufacturer, or the practitioner may assemble the assembly by placing the provided gingival healing cuff over the abutment, aligning the internal geometry of the hollow gingival healing cuff with that of the abutment, fitting the one over the other, as shown in FIGS. 33A-33B. A flowable composite or other bonding material may be used to adhere the two structures together, e.g., by placing such flowable composite or other bonding material onto one or both of the abutment surface and the gingival healing cuff surface that are to be mated together. The two structures may then be secured to one another by simply exposing the assembly to a dental curing light (e.g., UV light, of curing wavelengths, such as less than 450 nm, such as about 350 to about 400 nm). Such a flowable composite is an improved alternative to a bis-acrylic resin, which while works, does not provide as strong a bond as is achieved with such a flowable composite. An example of a suitable flowable composite is GrandioSO light flow, available from Voco Dental, which is a dental filling material, including 10-25% by weight 1,6-hexanediylbismethacrylate, 2.5-5% aliphatic dimethacrylate(s), 2.5-5% BISGMA, 2.5-5% triethylene glycol dimethacrylate, and a major fraction (e.g., as much as 70-80%) filler. A wide variety of other flowable dental composites or other bonding material may also be suitable for use.

As shown, the top (coronal) face of the gingival healing cuff may advantageously include a hex shaped opening 120. Such an opening allows insertion of a hex tool into the top of the gingival healing cuff, and torque testing of the assembly and associated dental implant. Other shaped openings may also be possible, e.g., so long as they similarly allow for such similar torque testing benefits. As shown in FIGS. 18 and 26, a generally vertical hemispherical or other shaped channel can be provided adjacent opening 120, oriented on the buccal face, just as rectangular buccal box 104. Such channel 121 may be useful as an additional marker for orientation, e.g., once the abutment with the gingival healing cuff has been seated, which would result in the rectangular buccal box 104 being covered by gingival tissue in many cases. Such a feature can also aid in any scanning process, for orientation of the gingival healing cuff with the abutment and ultimately with the implant and the surrounding teeth. Applicant also notes that with a contemplated scanning process, the practitioner may use a dental bur to form a uniquely identifiable surface structure marker on each gingival healing cuff, which uniquely identifiable surface structure marker will be scanned and used for fabrication of the final prosthesis.

While typical commercial abutments are often provided with a length of 10-12 mm, the abutment included in the present assemblies may be shorter, e.g., such as no more than about 7 mm, no more than about 5 mm, no more than about 4 mm, no more than about 3 mm, such as from about 3 mm to about 7 mm, or about 2.5 mm to about 4 mm in length. Such abutments may be cut to such shorter length, or may be formed to such length during initial manufacture, particularly where provided by Applicant, rather than using commercially available abutments for the core portion of the assembly.

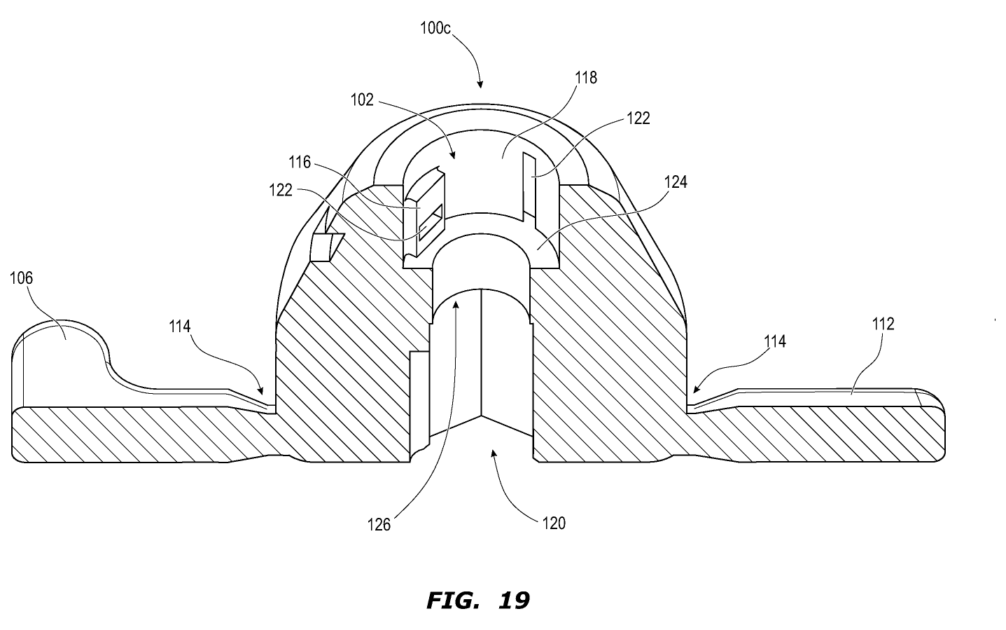

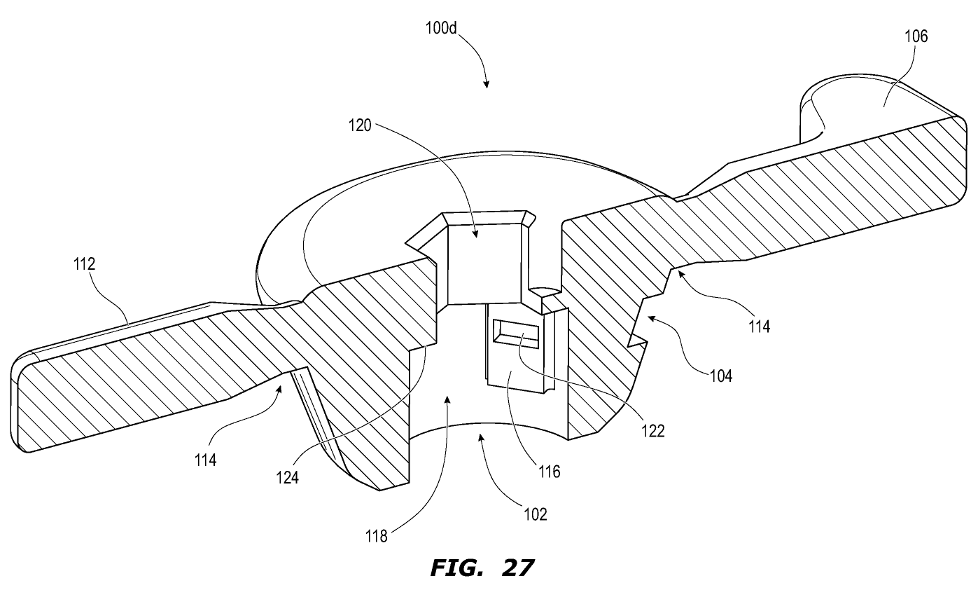

In an embodiment, the abutment may include a generally horizontal groove or recess 152 on the abutment (See FIG. 33A). The horizontal groove on the titanium abutments may primarily be to assist in retention of the gingival healing cuff or prosthetic while the vertical walls corresponding to flat faces 116 within this portion coronal to the abutment platform 108 are to help prevent rotation of the gingival healing cuff or prosthetic placed on the abutment. With both the vertical walls along with the horizontal grooves, there is presumed to be stability of any overlying prosthetic. However, it should be noted that Applicant has included in the interior surface of the gingival healing cuff, features to allow the gingival healing cuff to seat along the vertical walls to allow for correct alignment of the gingival healing cuff in relation to the implant abutment and rotational timing (i.e., rotational orientation) with the implant. All 3 such structures (implant, abutment, and gingival healing cuff) should be properly aligned or “timed”. Applicant has also provided other features (e.g., vertical recess boxes with dovetail grooves and/or other retentive structures 122(see particularly FIGS. 17 and 19 of gingival healing cuff 100c and FIGS. 25 and 27 of gingival healing cuff 100d) embedded in the internal walls of the abutment receiving area 102 of the gingival healing cuff to allow flowable composite or other bonding material to enter into and when cured to allow for a tight bond with the titanium or other abutment, all while accounting for the polymerization shrinkage of the composite resin or other bonding material. The particular internal geometry provided within recess 102 of the gingival healing cuff has required significant effort to overcome problems associated with shrinkage of the composite or other bonding material and ensure a stable, strong and predictable bond with the abutment. For example, such bonding and compensatory structures include generally vertical and generally horizontal grooves, and circular or other shaped indentations with or without internal locking geometry (e.g., dove tails) which allow for bonding material to be received such that a secure bond of the abutment and gingival healing cuff can be attained. In addition, Applicant has been not only modifying the height of the abutments (e.g., cut them down to about 2.5 to 4 mm), but has been placing a plurality (e.g., two) divots 154 (e.g., or formed chairside with a bur) on the sides of the abutments to assist in additional retention. The grooves and divots 152, 154 therefore also assist with additional retention. In another embodiment, one can provide or otherwise form (e.g., chairside) a divot or other retention recess on one or both of the rounded (non-flat) sides 118.

In any of the described embodiments, the assembly may include a plurality of available gingival healing cuffs, each with a different size or configuration, wherein each gingival healing cuff includes a hollow opening 102 at a center portion of the gingival healing cuff, for receipt of the geometry of the abutment. In an embodiment, the hollow opening in each gingival healing cuff of a given kit is identically sized. In another embodiment, the hollow openings 102 can be of different sizes and/or shapes, e.g., on gingival healing cuffs that are of different shapes so they could fit over the abutments if they were of different sizes, or mating shapes. As noted previously, the internal mating geometry of the gingival healing cuff may include a keyed arrangement relative to the abutment to be received therein. Such a keyed arrangement may not permit relative rotation of the two structures, once coupled together. Such keyed arrangement may also offer only a single rotational alignment between the two structures, during assembly of the gingival healing cuff over the abutment. For example, a square or hexagonal keyed arrangement does not offer such, as a hexagonal keyed arrangement prevents rotation once assembled, but there are 6 possible rotational alignments that are possible between the gingival healing cuff and abutment. Providing a configuration with only a single possible rotational alignment is beneficial to ensure proper “timing” alignment of the two coupled structures.

In any of the described embodiments, the gingival healing cuff may include at least one of a buccal or lingual handle portion or alignment bodies 106, 112 extending from the gingival healing cuff. In another embodiment, no such handle(s) are provided. The provided rectangular box or other timing alignment structure 104 provided on the buccal surface is also helpful in ensuring the practitioner knows the proper orientation of the assembly, including depth of the apical platform where abutment (seating) of the gingival healing cuff platform on the abutment platform and/or on the implant platform occurs.

In any of the described embodiments, and as shown in FIG. 33A, the abutment 150 can include one or more recessed portions in an exterior periphery of the coronal portion of the abutment above platform 108, for reception of a flowable composite, dental cement, or other curable or bonding material for adhering the abutment to an associated gingival healing cuff. Similarly, such recessed portions could be provided in the interior periphery of the recess 102 of the gingival healing cuff (e.g., structures 122 shown in FIGS. 17, 19, 25 and 27. In either case, the recessed portion(s) provide space for the flowable composite, dental cement, or other curable or bonding material, to be located, and adhere the two structures together. It will be appreciated that a wide variety of bonding materials may be used to secure the gingival healing cuff to the abutment, and to secure any dental prosthesis (e.g. ceramic or other crown, bridge, cusp, etc.) to such component(s). The terms flowable composite, dental cement, or other curable or bonding material are meant to broadly encompass such, whether curing or setting is achieved through exposure to UV wavelengths, or other curing or setting mechanism. A wide variety of biocompatible bonding materials may be suitable for use, and are encompassed by the employed terms.

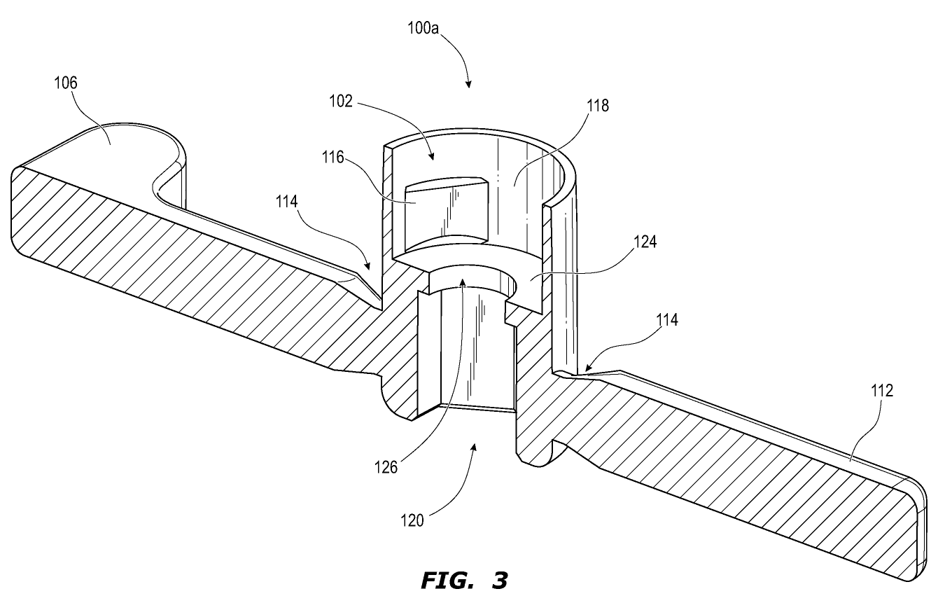

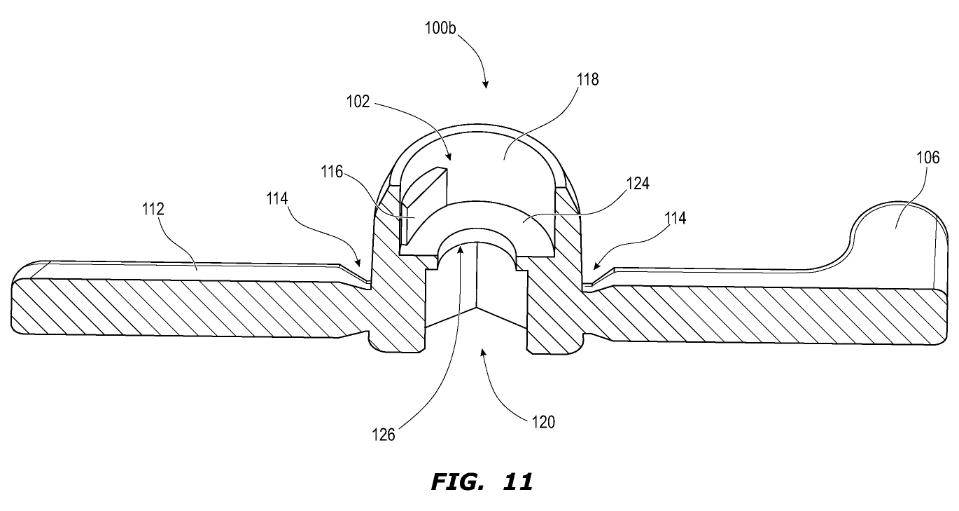

FIGS. 3, 11, 19 and 27 perhaps best illustrate the geometry of apical recess 102 configured to receive the coronal portion of a corresponding abutment. In addition to the noted features for providing a keyed alignment configuration and retention grooves or recesses 122 within the recess 102 for holding curable composite or other bonding material, a central floor 124 is also provided, e.g., including an annular opening 126, connecting apical recess 102 to the hexagonal shaped opening 120, suitable for torque testing.

Similarly, the gingival healing cuff may include one or more injection ports 123 (e.g., small holes on mesial and/or distal sides of the gingival healing cuff), as shown in FIGS. 33A-33B. The practitioner may apply a drop of composite or other bonding material at one or more locations on the side(s) of the gingival healing cuff, and a drop of composite or other bonding material on the abutment. Providing such injection ports in the gingival healing cuff, allow one to inject composite or other bonding material, having it flow within and around the recessed portion(s) noted above, and flow out the other injection hole port. For example, placement of injection ports into the gingival healing cuff body may better facilitate bonding of the abutment and gingival healing cuff together, e.g., by use of biocompatible injectable composite or other bonding material through such ports. Similar structure could be used for attaching a crown, cusp, bridge or other prosthetic over the gingival healing cuff body.

In any of the described embodiments, even if the abutment is formed of a material that is not transparent to UV curing light wavelengths (e.g., titanium), the degree of transparency of the gingival healing cuff structure may be sufficient for UV light to pass through the gingival healing cuff, to cure material present in any provided recesses, etc., to effectively adhere the two structures together.

In another embodiment, even if the abutment is not formed of a material that is transparent to UV curing light wavelengths (e.g., such as titanium, zirconium, titania, zirconia, etc.), UV curing of a given composite or other desired curable or other bonding material used for bonding two structures together (e.g., the abutment and a gingival healing cuff) may still be possible by providing perforations through such abutment, to allow transmission of UV curing light wavelengths therethrough.

The gingival healing cuffs and/or abutments may include any of various scanning features, e.g., as described in U.S. Application No. 19/060,102 filed February 21, 2025, entitled OMNI-ABUTMENT CORE AND METHODS OF USE, and U.S. Application No. 63/567,706 filed March 20, 2024, entitled CT SCANNING OF INTRAORAL SOFT TISSUE AND DENTAL STRUCTURES, and PCT Application No. PCT/US25/20616 filed March 20, 2025, entitled CT SCANNING OF INTRAORAL SOFT TISSUE AND DENTAL STRUCTURES, each of which is herein incorporated by reference. By way of example, the rectangular or other shaped timing alignment structure positioned apical to the T-shaped alignment handle is an example of such a feature, which aids in determining orientation of the gingival healing cuff body, and any attached structures, within a CT or similar scan.

Another example of such external periphery placed structures that would aid in determining orientation when scanning would be the placement of small dots or other markers (e.g., protrusions, recesses, or even just placement of something with a color contrast) on the outside peripheral surface of the gingival healing cuff, that would help the scanner pick up the geometry better. Such features could be provided during manufacture or added by the practitioner chairside. Ideally, such features used for aiding in orientation within a captured scan would be positioned on any of the side surfaces (mesial, distal, lingual, or buccal, or the coronal (top) surface).

Older scanners in particular do not pick up such details and features as well. For example, Applicant has sometimes drawn various differing shapes (e.g., a circle, square, & triangle (penciled in) on different faces), so that the scanner would capture that, aiding in later determination of correct orientation of the captured scan. By way of example, some scanners can pick up not only shape/size differences, but also capture color contrast differences (e.g., resulting from penciling in or otherwise applying identifying shapes/markers on various faces). For example, depending on the type of material the gingival healing cuff is made from, e.g., a relatively radiodense material, such markers in or on the gingival healing cuff can be picked up by a CT or other scanner as such markers may be less (or more) radiodense, so as to show up. In addition, Applicant recognizes that scanners will continue to improve, providing even better resolution and differentiation between various materials, interfaces, and geometry in the near future. By way of further example, such exemplary described features may relate to digital scanning and possibly photogrammetry.

As will be apparent, the described assemblies and components thereof may be used, e.g., in conjunction with a crown, cusp, bridge or other prosthesis added over the gingival healing cuff. Such additional coronal structure could be added with composite, or any other compatible bonding material, as an optional part to the already seated abutment and gingival healing cuff. Any of such structures (including a crown, cusp, bridge or other prosthesis) can be formed using additive manufacturing (e.g., 3D printing) or other desired technique.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

1. An assembly comprising (i) an abutment formed from a ceramic or metal material or a polymer having a minimum desired tensile strength, and (ii) a gingival healing cuff, wherein the gingival healing cuff fits over the abutment, wherein the gingival healing cuff includes an internal shape and geometry that mates with an exterior transverse cross-sectional shape of the abutment, wherein the exterior transverse cross-sectional shape of the abutment is a closed shape including a curved face, and one or more flat faces.

2. The assembly as recited in claim 1, wherein the abutment comprises titanium, zirconium, another metal, or a ceramic.

3. The assembly as recited in claim 1, wherein the abutment comprises at least one of a 3D printable resin material, other 3D printable material (e.g., 3D printable metal), or a castable material (e.g., polyether ether ketone (PEEK)).

4. The assembly as recited in claim 1, wherein the gingival healing cuff comprises a 3D printable resin material or other material which is readily shapable so that a user can remove material from, or add material to the gingival healing cuff.

5. A system including a plurality of assemblies as in claim 1, wherein the system includes a plurality of available gingival healing cuffs, each with a different size or configuration, available in different lengths, wherein each gingival healing cuff includes a hollow opening at a center portion of the gingival healing cuff, for receipt of an external surface structure of the abutment, wherein the hollow opening in each gingival healing cuff of the system is identically sized, or wherein the hollow openings are made to fit over specific abutment sizes and/or configurations.

6. A system including a plurality of assemblies as in claim 1, wherein the system includes a plurality of available gingival healing cuffs, selected from the following:
(a) shaped and short– including a plurality of available gingival healing cuffs, each of a different shape for a particular tooth position, provided with anatomical shapes to provide anatomical filling of an emergence portion of a subgingival void of a given tooth position, each of the gingival healing cuffs having a length from 3 to 7 mm;
(b) shaped and long – including a plurality of available gingival healing cuffs, each of a different shape for a particular tooth position, provided with anatomical shapes to provide anatomical filling of an emergence portion of a subgingival void of a given tooth position, each of the gingival healing cuffs having a length from 8 to 12 mm;
(c) circular and short– including a plurality of available gingival healing cuffs, each of a different size for a particular tooth position, provided with a circular coronal profile, each of the gingival healing cuffs having a length from 3 to 7 mm;
(d) circular and long – including a plurality of available gingival healing cuffs, each of a different size for a particular tooth position, provided with a circular coronal profile, each of the gingival healing cuffs having a length from 8 to 12 mm.

7. A system including a plurality of assemblies as in claim 1, wherein the system includes a plurality of available gingival healing cuffs, available in at least 9 anatomical shapes selected from maxillary molar, maxillary premolar, maxillary canine, maxillary lateral incisor, maxillary central incisor, mandibular incisor, mandibular canine, mandibular premolar, mandibular molar, primary maxillary molar, and/or primary mandibular molar.

8. The assembly as recited in claim 1, further comprising at least one of a buccal alignment body or lingual alignment body extending from the gingival healing cuff.

9. The assembly as recited in claim 8, wherein the gingival healing cuff further includes a rectangular box or other timing alignment structure positioned apical to the buccal alignment body.

10. The assembly as recited in claim 9, wherein the rectangular box or other timing alignment structure is configured as a horizontal box recessed into a peripheral face of the gingival healing cuff, wherein the horizontal box is positioned apical to the buccal alignment body.

11. The assembly as recited in claim 8, wherein the buccal alignment body or lingual alignment body includes a portion of reduced cross-sectional thickness adjacent a proximal end of the buccal alignment body or lingual alignment body, to facilitate break away by a practitioner once the buccal alignment body or lingual alignment body is no longer needed.

12. The assembly as recited in claim 1, wherein the gingival healing cuff includes a hexagonal or other shaped opening in a coronal face of the gingival healing cuff to allow for in-situ torque testing of the assembly and an associated implant.

13. The assembly as recited in claim 1, wherein an interior of the gingival healing cuff includes internal structure where the gingival healing cuff attaches to the abutment that allows for securing the abutment and the gingival healing cuff together, including compensation of polymerization shrinkage of a composite or other bonding material used to attach the gingival healing cuff to the abutment.

14. The assembly as recited in claim 1, wherein the abutment is formed of a material that is transparent to UV curing light wavelengths, such that UV light positioned in a hollow core of the abutment passes through portions of a core wall of the abutment to assist in curing composite or other bonding materials used to attach the gingival healing cuff or other device to the abutment.

15. The assembly as recited in claim 1, wherein the abutment is formed of a material that is not transparent to UV curing light wavelengths, the abutment further comprising perforations configured to allow transmission of UV curing light wavelengths therethrough, such that UV light positioned in a hollow core of the abutment passes through such perforations of a core wall defining the hollow core to assist in curing composite or other bonding materials used to connect the gingival healing cuff or other device to the abutment.

16. A method of use, the method comprising:
providing an abutment formed from a ceramic or metal material or a polymer having a minimum desired tensile strength;
providing a gingival healing cuff, wherein the gingival healing cuff fits over the abutment, wherein the gingival healing cuff includes an internal shape and geometry that mates with an exterior transverse cross-sectional shape of the abutment, wherein the exterior transverse cross-sectional shape of the abutment is a closed shape including a curved face, and one or more flat faces; and
applying a composite or other bonding material to an exterior of the abutment and/or interior of the gingival healing cuff and positioning the gingival healing cuff over the abutment, and securing the gingival healing cuff over the abutment.

17. The method as recited in claim 16, further comprising providing or forming one or more indentations into exterior faces of the abutment for reception of composite or other bonding material, to provide additional retention when securing the gingival healing cuff over the abutment.

18. The method as recited in claim 16, wherein the gingival healing cuff further includes a rectangular box or other timing alignment structure positioned apical to a buccal alignment body, wherein the rectangular box or other timing alignment structure is configured as a horizontally oriented rectangular box recessed into a peripheral buccal face of the gingival healing cuff, apical to the buccal alignment body, the method further comprising applying a composite or other bonding material into the horizontally oriented rectangular box, wherein the applied composite or other bonding material has a contrasting color as compared to surrounding structures, to aid a practitioner in recognizing proper orientation of the abutment and gingival healing cuff.

19. The method as recited in claim 16, wherein the gingival healing cuff includes a hexagonal or other shaped opening in a coronal face of the gingival healing cuff to allow for in-situ torque testing of the abutment, gingival healing cuff and an associated implant, the method further comprising inserting a torque wrench or other tool for testing torque into the hexagonal or other shaped opening, to test torque of an underlying implant.

20. The method as recited in claim 16, further comprising attaching a crown, cusp, bridge or other prosthesis over the gingival healing cuff.
